(19) United States
(12) Patent Application Publication
(10) Pub. No.: US 2026/0266601 A1
(43) Pub. Date: Sep. 10, 2026

(54) APPARATUS AND METHOD FOR MEASURING BATTERY CELL PROFILE

(71) Applicant: SAMSUNG SDI CO., LTD., Yongin-si (KR)

(72) Inventor: Ju Yeong KIM, Suwon-si (KR)

(21) Appl. No.: 19/437,568

(22) Filed: Dec. 31, 2025

(30) Foreign Application Priority Data
Mar. 10, 2025 (KR) 10-2025-0030554

(51) Int. Cl. G01B 21/20; H01M 10/42

(52) U.S. Cl. CPC G01B 21/20; H01M 10/4285

(57) ABSTRACT

An apparatus for measuring a battery cell profile, the apparatus including a taping module including a roller and a roller driver, a processor electrically connected to the taping module, and a memory which stores a command executed by the processor, the memory being electrically connected to the processor, wherein the processor is configured to measure a profile of a battery cell using a contact position at which the roller comes into contact with a surface of the battery cell to bring insulating tape into close contact with the battery cell.

### CROSS-REFERENCE TO RELATED APPLICATION

This application claims priority to and the benefit of Korean Patent Application No. 10-2025-0030554, filed on Mar. 10, 2025, the disclosure of which is incorporated herein by reference in its entirety.

### BACKGROUND

### 1. Field

Embodiments of the present disclosure relate to an apparatus and method for measuring a battery cell profile.

### 2. Description of the Related Art

A battery module includes a plurality of battery cells. An electrolyte, a positive electrode plate, and a negative electrode plate are disposed in a case provided as one compartment to form the battery cell.

A profile of the battery cell is an important factor required for assembling of a battery module or battery pack including the battery cell. The profile of the battery cell may be measured based on a thickness of the battery cell.

The thickness of the battery cell may be a one dimension measurement item of a battery and may be measured through a laser or a contact type measuring instrument in an unpressed state. For example, the thickness of the battery cell is measured through pointers at both sides thereof in a state in which the battery cell is taped using insulating tape and fixed by a gripper. That is, the profile of the battery cell may be measured after the battery cell is taped using the insulating tape through an external insulating process.

The above information disclosed in this Background section is for enhancement of understanding of the background of the present disclosure, and therefore, it may contain information that does not constitute related (or prior) art.

### SUMMARY

Embodiments include an apparatus for measuring a battery cell profile, the apparatus including a taping module including a roller and a roller driver, a processor electrically connected to the taping module, and a memory which stores a command executed by the processor, the memory being electrically connected to the processor, wherein the processor is configured to measure a profile of a battery cell using a contact position at which the roller comes into contact with a surface of the battery cell to bring insulating tape into close contact with the battery cell.

The processor may be configured to measure the profile of the battery cell using a vertical distance between a predetermined reference surface and the contact position.

The predetermined reference surface may include at least one of a first reference surface defined by a center line in a thickness direction and a center line in a width direction of the battery cell, a second reference surface defined by the center line in the width direction and a center line in a longitudinal direction of the battery cell, and a third reference surface defined by the center line in the thickness direction and the center line in the longitudinal direction of the battery cell.

The predetermined reference surface may be set for each profile measurement section of the battery cell.

The profile measurement section of the battery cell may include at least one of both front surface portions, side surface portions, and a bottom portion of the battery cell.

The processor may be configured to set coordinates on the predetermined reference surface, and measure the vertical distance for each set of coordinates.

The processor may be configured to calculate an initial distance between a position of the predetermined reference surface and an initial position of the roller while moving the roller toward the battery cell, a movement distance of the roller using the initial position of the roller and the contact position, and a distance between the predetermined reference surface and the contact position by deducting the movement distance from the initial distance of the roller.

The processor may be configured to calculate the distance between the predetermined reference surface and the contact position based on an amount of a change in contact position according to close movement of the roller while bringing the roller into close contact with the battery cell and moving the roller.

Embodiments include an apparatus for measuring a battery cell profile, the apparatus including a taping module configured to bring insulating tape into close contact with a battery cell and tape the battery cell using a roller, and a processor configured to measure a contact position at which the roller comes into contact with a surface of the battery cell while controlling the taping module to tape the battery cell and measure a profile of the battery cell using the contact position.

The taping module may include a roller driver configured to move the roller toward the battery cell or configured to bring the roller into close contact with the battery cell and tape the battery cell with the insulating tape.

The processor may be configured to measure the profile of the battery cell using a vertical distance between a predetermined reference surface and the contact position.

The processor may be configured to set coordinates on the predetermined reference surface and measure the vertical distance between the predetermined reference surface and the contact position for each set of coordinates.

The processor may be configured to calculate an initial distance between a position of the predetermined reference surface and an initial position of the roller while moving the roller toward the battery cell, a movement distance of the roller using the initial position of the roller and the contact position, and the vertical distance between the predetermined reference surface and the contact position by deducting the movement distance from the initial distance of the roller.

The processor may be configured to calculate the vertical distance between the predetermined reference surface and the contact position based on an amount of a change in contact position according to close movement of the roller while bringing the roller into close contact with the battery cell and moving the roller.

Embodiments include a method of measuring a battery cell profile, the method including measuring, by a processor, a contact position at which a roller comes into contact with a battery cell while taping the battery cell with insulating tape using the roller, and measuring, by the processor, a profile of the battery cell using the contact position.

Measuring the profile of the battery cell may include measuring, by the processor, the profile of the battery cell using a vertical distance between a predetermined reference surface and the contact position.

Measuring the profile of the battery cell may include measuring, by the processor, sets of coordinates on the predetermined reference surface, and measuring the vertical distance between the predetermined reference surface and the contact position of each of the sets of coordinates.

Measuring the profile of the battery cell may include calculating, by the processor, an initial distance between a position of the predetermined reference surface and an initial position of the roller while moving the roller toward the battery cell, a movement distance of the roller using the initial position of the roller and the contact position, and the vertical distance between the predetermined reference surface and the contact position by deducting the movement distance from the initial distance of the roller.

Measuring the profile of the battery cell may include calculating, by the processor, the vertical distance between the predetermined reference surface and the contact position based on an amount of change in contact position according to close movement of the roller while bringing the roller into close contact with the battery cell and moving the roller.

### BRIEF DESCRIPTION OF DRAWINGS

Features will become apparent to those of ordinary skill in the art by describing in detail exemplary embodiments with reference to the attached drawings, in which:

FIG. 1 is a block diagram illustrating an apparatus for measuring a battery cell profile according to one or more embodiments of the present disclosure;

FIGS. 2A-2E are views sequentially illustrating a battery cell taping process according to one or more embodiments of the present disclosure;

FIG. 3 is a conceptual view illustrating an insulating tape attachment process using a roller according to one or more embodiments of the present disclosure;

FIG. 4 is a view illustrating a center line in a thickness direction, a center line in a width direction, and a center line in a longitudinal direction according to one or more embodiments of the present disclosure;

FIG. 5 is a view illustrating a reference surface of a battery cell according to one or more embodiments of the present disclosure;

FIGS. 6A-6C are views illustrating coordinates of the reference surface of the battery cell according to one or more embodiments of the present disclosure;

FIGS. 7A-7C are views illustrating examples of measuring a profile according to one or more embodiments of the present disclosure;

FIG. 8 is a flowchart illustrating a method of measuring a battery cell profile according to one or more embodiments of the present disclosure;

FIG. 9 is a table showing measurement coordinates of a front surface portion according to one or more embodiments of the present disclosure; and

FIGS. 10A and 10B are views showing a measurement result of a front surface profile according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure. Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

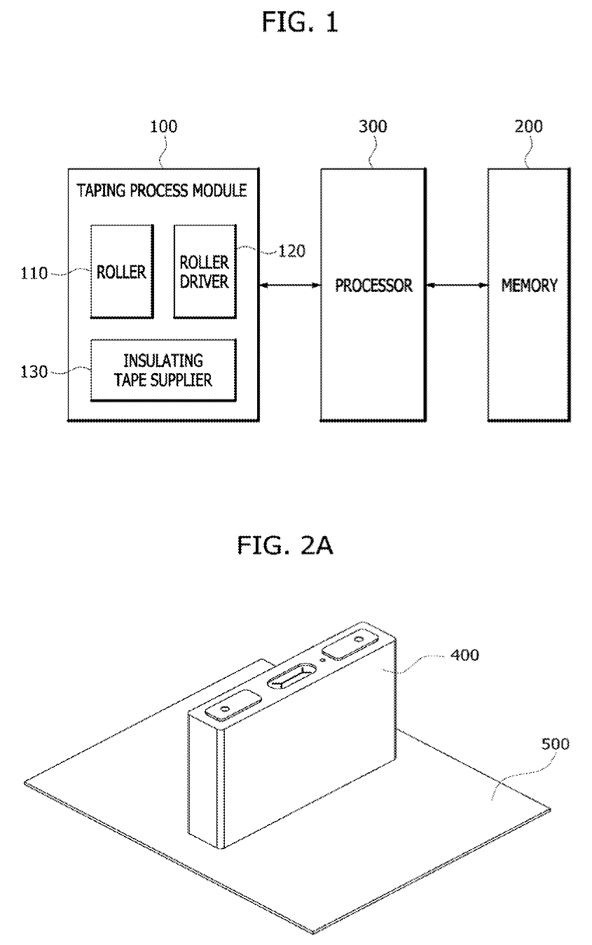

FIG. 1 is a block diagram illustrating an apparatus for measuring a battery cell profile according to one or more embodiments of the present disclosure.

Referring to FIG. 1, the apparatus for measuring a battery cell profile according to one or more embodiments of the present disclosure may include a taping process module 100 (or just a “taping module”), a memory 200, and a processor 300.

The taping process module 100 may perform a taping process of taping a battery cell 400 with insulating tape 500. Due to the taping process, a cell-to-cell short of the battery cell 400 can be prevented, and the battery cell 400 can be insulated from external foreign matter.

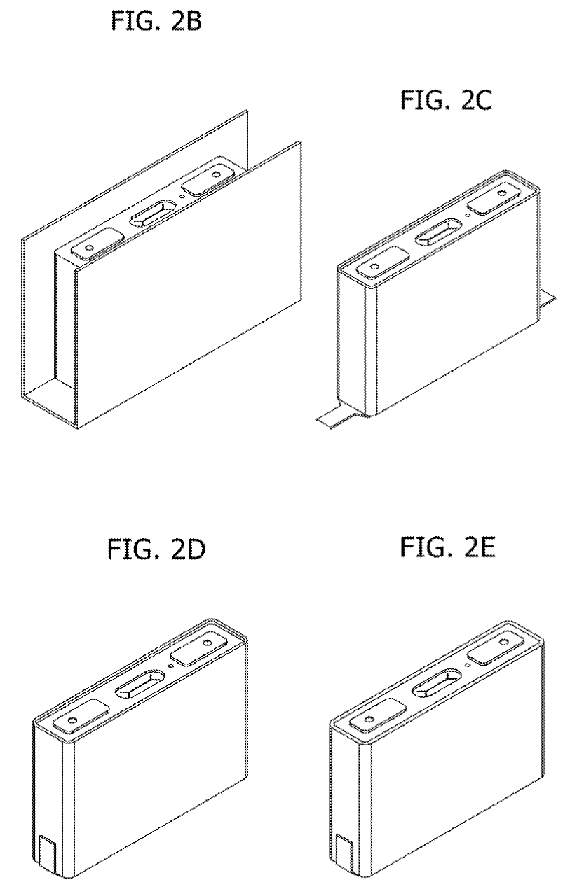

FIGS. 2A-2E are views sequentially illustrating the battery cell taping process according to one or more embodiments of the present disclosure.

In FIGS. 2A-2E, a process of supplying the insulating tape 500 and taping a surface of the battery cell 400 with the insulating tape 500 is sequentially illustrated.

The taping process module 100 may include a roller 110, a roller driver 120, and an insulating tape supplier 130.

The insulating tape supplier 130 may supply the insulating tape 500.

The roller 110 may tape the surface of the battery cell (nude cell) 400 with the insulating tape 500 supplied from the insulating tape supplier 130. To this end, the roller 110 may move toward the battery cell 400, come into contact with the surface of the battery cell 400, and move vertically along the surface of the battery cell 400 while in contact with the battery cell 400 to bring the insulating tape 500 into close contact (e.g., direct contact) with the battery cell 400.

The roller 110 may be provided as a plurality of the roller 110 according to a taping section of the battery cell 400, the plurality of the roller 110 may bring the insulating tape 500 into close contact with the battery cell 400 in various directions of the battery cell 400. The taping section may be both front surface portions, side surface portions, and a bottom portion but this may vary.

The roller 110 may be manufactured of a material with a relatively high hardness in order to minimize deformation during compression rolling. The material of the roller 110 may be urethane with a high hardness or silicon with a high hardness but this may vary.

The roller driver 120 may drive the roller 110 to bring the insulating tape 500 into contact with the surface of the battery cell 400.

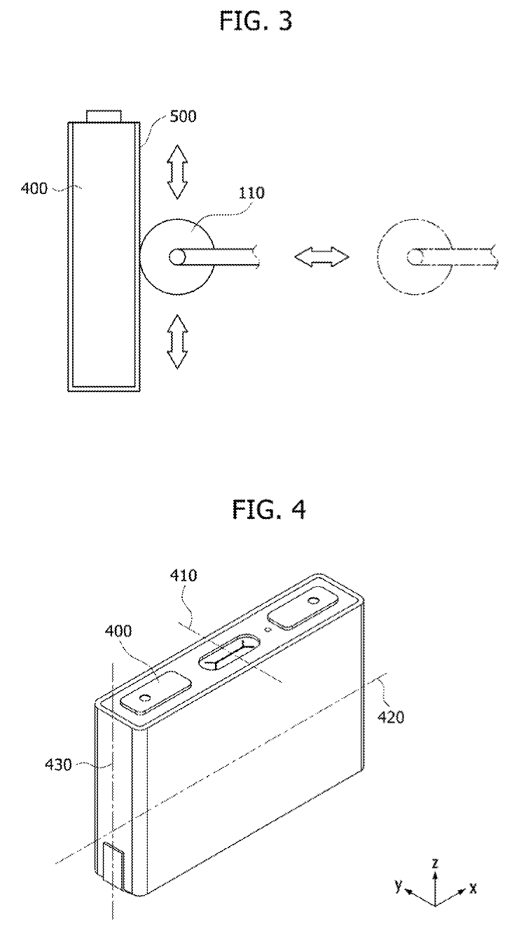

FIG. 3 is a conceptual view illustrating an insulating tape attachment process using the roller according to one or more embodiments of the present disclosure.

Referring to FIG. 3, the roller driver 120 may move the roller 110 toward or away from the battery cell 400 to bring the roller 110 into contact with the surface of the battery cell 400. The roller driver 120 moves the roller 110 vertically while the roller 110 is in contact with the surface of the battery cell 400, that is, performs the compression rolling such that the insulating tape 500 is in close contact (e.g., direct contact) with the surface of the battery cell.

As described above, during a process of (e.g., while) bringing the insulating tape 500 into close contact with the battery cell 400, the roller 110 may be used to measure a profile of the battery cell 400 during the taping process. That is, during the taping process, a position of the roller 110 may be measured, and the measured position of the roller 110 may be used to measure the profile of the battery cell 400. This will be described below.

The profile of the battery cell 400 may be a shape of the surface itself of the battery cell 400 and may be a set of vertical distances between contact positions between the roller 110 and a reference surface. The contact positions and the reference surface will be described below.

The roller 110 may be formed to have a set width for profile measurement accuracy. For example, the roller 110 may be manufactured to have a relatively smaller width than both front surface portions, the side surface portions, and the bottom portion of the battery cell 400. When the width of the roller 110 is relatively wider, a taping process time may be reduced, but the profile measurement accuracy of the battery cell 400 may be reduced. Accordingly, the roller 110 having the relatively smaller width than both front surface portions, the side surface portions, and the bottom portion of the battery cell 400 may be rolled a plurality of times, and the contact positions between the roller 110 and the battery cell 400 at several locations may be measured in this process, thereby improving the profile measurement accuracy. The width of the roller 110 may range from 30 to 50 mm. The width of the roller 110 may be variously set in consideration of a width of the taping section of the battery cell 400, process efficiency, and the profile measurement accuracy.

The memory 200 may store various data used by the processor 300. The data may include commands for executing operations or steps according to the embodiment of the present disclosure. That is, the memory 200 may store commands for controlling the taping process module 100 to perform the taping process and measuring a profile of the battery cell 400 using contact positions at which the roller 110 comes into contact with the surface of the battery cell 400 in this process.

The memory 200 may include at least one of a storage medium of a flash memory type, hard disk type, multimedia card micro type, or card type memory, a random access memory (RAM), a static random access memory (SRAM), a read-only memory (ROM), a programmable read-only memory (PROM), an erasable programmable read-only memory (EPROM), and an electrically erasable programmable read-only memory (EEPROM).

The processor 300 may be connected to the memory 200 and execute the commands stored in the memory 200. The processor 300 may execute the commands stored in the memory 200 to control at least another component (for example, a hardware or software component) connected to the processor 300 and perform various data processes and operations.

In addition, the processor 300 may be formed such that components for each function are divided at hardware, software, and logic levels. In this case, designated hardware for executing each function may be used. To this end, the processor 300 may be implemented as or include at least one of an application specific integrated circuit (ASIC), a digital signal processor (DSP), programmable logic devices (PLDs), field programmable gate arrays (FPGAs), a central processing unit (CPU), microcontrollers, and/or microprocessors.

The processor 300 may be implemented as the CPU or a system on chip (SoC), may drive an operating system or application to control a plurality of hardware or software components connected to the processor 300, and may perform various data processes and operations. The processor 300 may be configured to execute at least one command stored in the memory 200 and store execution result data thereof in the memory 200.

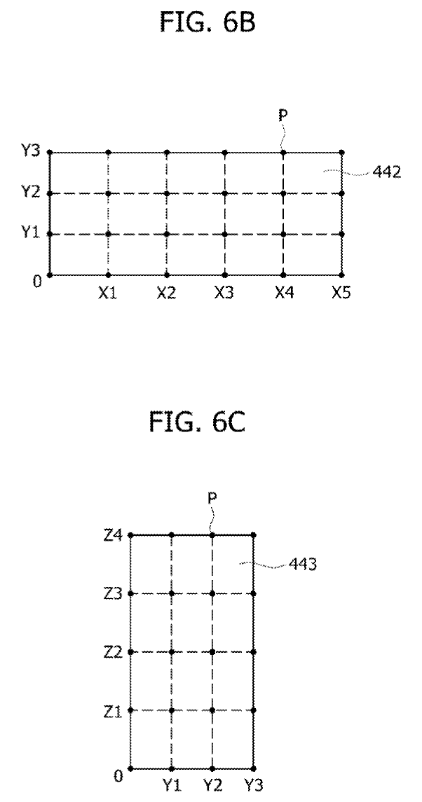

The processor 300 may control the taping process module 100 to perform the taping process. In the taping process, the processor 300 may control the roller driver 120 based on a current position of the roller 110. The processor 300 may measure a contact position between the roller 110 and the surface of the battery cell 400 and measure a profile of the battery cell 400 based on the measured contact position. To this end, the processor 300 may form a virtual reference surface 440 in the battery cell 400 and measure a distance between the reference surface 440 and the roller 110 based on the contact position between the roller 110 and the surface of the battery cell 400 (see FIG. 5). The processor 300 may measure the profile of the battery cell 400 based on the distance between the reference surface 440 and the roller 110.

Specifically, when the battery cell 400 is disposed at a process position for the taping process, the processor 300 may form the reference surface 440 using a virtual center line of the battery cell 400.

The reference surface 440 may be a completely flat surface which is not uneven and may serve as a reference for measuring a profile of the battery cell 400.

The reference surface 440 may be a virtual surface set in the battery cell 400 for measuring the profile of the battery cell 400.

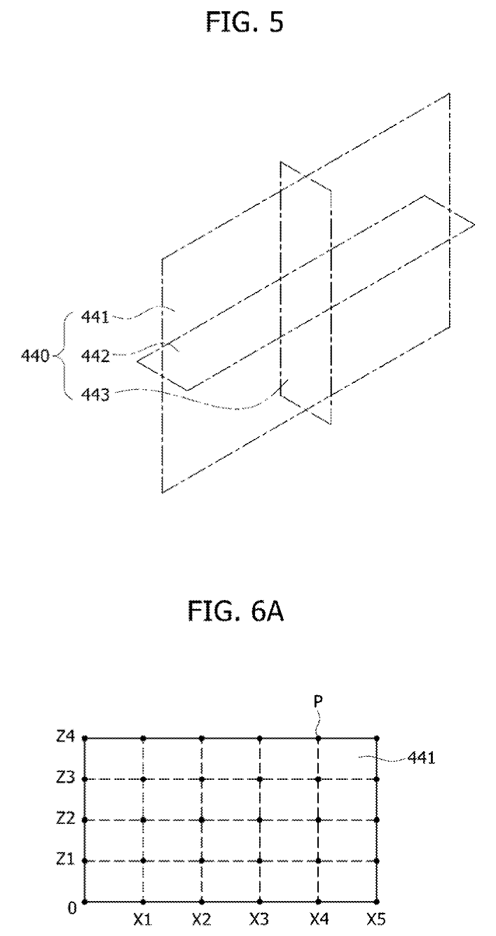

FIG. 4 is a view illustrating a center line in a thickness direction, a center line in a width direction, and a center line in a longitudinal direction according to one or more embodiments of the present disclosure.

FIG. 4 shows a virtual center line 410 in the longitudinal direction (x-axis) (e.g., the virtual center line 410 is in the middle of the longitudinal direction; in other words line 410 splits the battery in half along the x-axis direction), a virtual center line 420 in the width direction (z-axis) (e.g., virtual center line 420 splits the battery in half along the z-axis direction), and a virtual center line 430 in the thickness direction (y-axis) of the battery cell 400 (e.g., virtual center line 430 splits the battery in half along the y-axis direction).

The processor 300 may form the reference surface 440 using the center line 410 in the longitudinal direction (x-axis), the center line 420 in the width direction (z-axis), and the center line 430 in the thickness direction (y-axis) of the battery cell 400.

The reference surface 440 may include a first reference surface 441, a second reference surface 442, and a third reference surface 443.

The processor 300 may form the first reference surface 441, the second reference surface 442, and the third reference surface 443 using the center line 410 in the longitudinal direction (x-axis), the center line 420 in the width direction (z-axis), and the center line 430 in the thickness direction (y-axis) of the battery cell 400.

FIG. 5 is a view illustrating the reference surface of the battery cell according to one embodiment of the present invention.

Referring to FIG. 5, the first reference surface 441, the second reference surface 442, and the third reference surface 443 may be formed for each profile measurement section of the battery cell 400. The profile measurement section of the battery cell 400 may be both front surface portions, both side surface portions, and the bottom portion of the battery cell 400 and may match with the taping section.

The first reference surface 441 may be used to measure a profile of both front surface portions of the battery cell 400. The first reference surface 441 (xz plane) may be defined by the center line 430 in the thickness direction (y-axis) and the center line 420 in the width direction (z-axis).

The second reference surface 442 may be used to measure a profile of the bottom portion of the battery cell 400. The second reference surface 442 (xy plane) may be defined by the center line 420 in the width direction (z-axis) and the center line 410 in the longitudinal direction (x-axis).

The third reference surface 443 may be used to measure a profile of both side surface portions of the battery cell 400. The third reference surface 443 (yz plane) may be defined by the center line 430 in the thickness direction (y-axis) and the center line 410 in the longitudinal direction (x-axis) of the battery cell 400.

The processor 300 may set coordinates on the reference surface 440. That is, the processor 300 may set the coordinates on each of the first reference surface 441, the second reference surface 442, and the third reference surface 443.

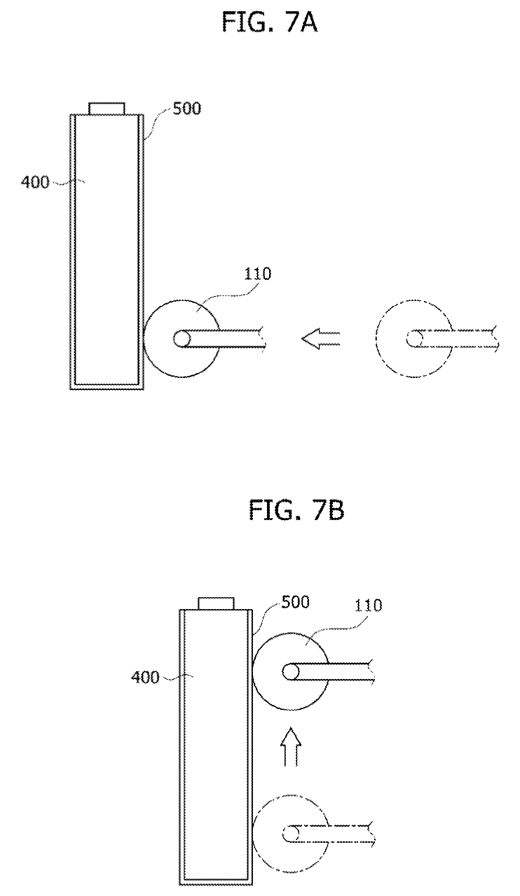

FIGS. 6A-6C are views illustrating the coordinates of the reference surface of the battery cell according to one or more embodiments of the present disclosure.

FIG. 6A shows coordinates (xn,0,zn) set on the first reference surface 441, FIG. 6B shows coordinates (xn,yn,0) set on the second reference surface 442, and FIG. 6C shows coordinates (0,yn,zn) set on the third reference surface 443.

As the coordinates are set on each of the first reference surface 441, the second reference surface 442, and the third reference surface 443, the processor 300 may measure distances between the reference surface 440 and the roller 110 for each set of coordinates.

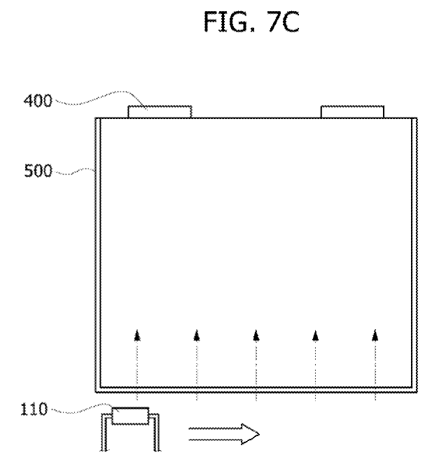

FIGS. 7A-7C are views illustrating an example of measuring a profile according to one or more embodiments of the present disclosure.

Referring to FIGS. 7A-7C, the processor 300 may control the taping process module 100 to perform a taping process.

The processor 300 may control the insulating tape supplier 130 to supply the insulating tape 500.

The processor 300 may move (e.g., may cause movement of) the roller 110 toward the battery cell 400 to bring the roller 110 into contact with the battery cell 400 and bring the insulating tape 500 into contact with the surface of the battery cell 400 through compression rolling.

During the taping process, the processor 300 may measure a profile of the battery cell 400 using a vertical distance between the reference surface 440 and a contact position.

The contact position may be a position at which the surface of the battery cell 400 and the roller 110 are in contact (e.g., via the insulating tape 500) with each other. The vertical distance may be a vertical distance from a point of coordinates of the reference surface 440 to the contact position. Accordingly, the vertical distance may be calculated for each of the coordinates of the reference surface 440.

First, the processor 300 may check an initial position of the roller 110. The initial position of the roller 110 may be a standby position before the roller 110 is moved. The processor 300 may calculate an initial distance between a position of the reference surface 440 and the initial position of the roller 110.

Then, as illustrated in FIG. 7A, the processor 300 may control the roller driver 120 to move the roller 110 toward the battery cell 400. In this case, the processor 300 may determine whether the roller 110 comes into contact with the surface of the battery cell 400. When the roller 110 comes into contact with the surface of the battery cell 400, the processor 300 may control the roller driver 120 to stop the movement of the roller 110 and measure a contact position at which the surface of the battery cell 400 and the roller 110 come into contact with each other. The processor 300 may calculate a movement distance of the roller 110 using the initial position of the roller 110 and the contact position.

Then, the processor 300 may calculate a vertical distance by deducting the movement distance from the initial distance of the roller 110.

Then, as illustrated in FIG. 7B, the processor 300 may control the roller driver 120 to move the roller 110 while the roller 110 is in close contact with the battery cell 400. In this process, the processor 300 may measure a contact position for each set of coordinates as described above and calculate a vertical distance between the contact position and the reference surface 440.

Meanwhile, the roller 110 may be formed to have the preset width as described above. In this case, as illustrated in FIG. 7C, the processor 300 may sequentially measure a profile as much as a width corresponding to the width of the roller 110.

The processor 300 may manage the vertical distances obtained at the coordinates in a profile form.

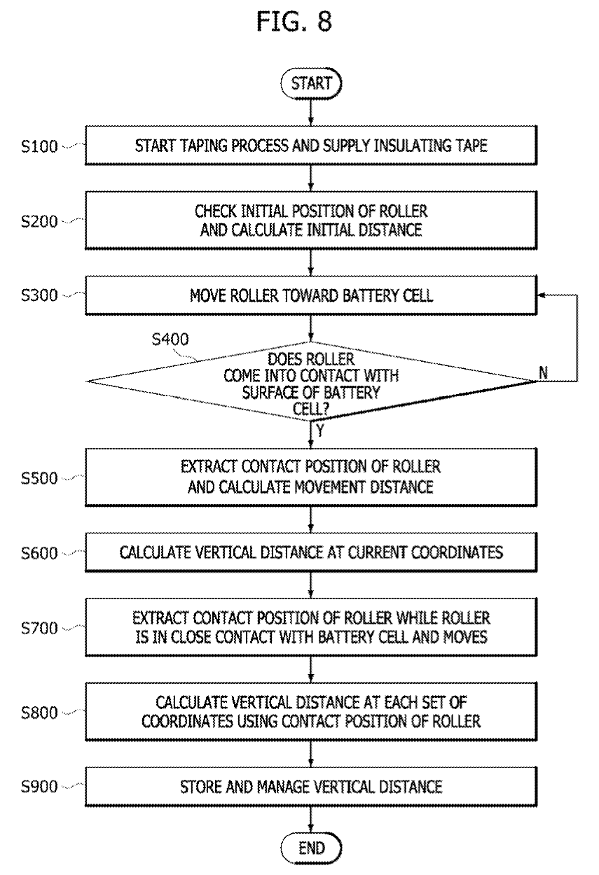

FIG. 8 is a flowchart illustrating a method of measuring a battery cell profile according to one or more embodiments of the present disclosure.

Referring to FIG. 8, when a taping process starts, the processor 300 may control the insulating tape supplier 130 to supply the insulating tape 500 (S100).

The processor 300 may check an initial position of the roller 110 and calculate an initial distance between a position of the reference surface 440 and the initial position (S200).

The processor 300 may control the roller driver 120 to move the roller 110 toward the battery cell 400 (S300). In this case, the processor 300 may determine whether the roller 110 comes into contact with the surface of the battery cell 400 (S400).

When the roller 110 is determined in operation S400 to have come into contact with the surface of the battery cell 400, the processor 300 may stop the movement of the roller 110 using the roller driver 120.

Then, the processor 300 may measure a contact position at which the surface of the battery cell 400 comes into contact with the roller 110. The processor 300 may calculate a movement distance of the roller 110 using the initial position of the roller 110 and the contact position (S500).

The processor 300 may calculate a vertical distance at current coordinates by deducting the movement distance from the initial distance of the roller 110 (S600).

Then, the processor 300 may control the roller driver 120 to move the roller 110 while the roller 110 is in close contact with the battery cell 400 and measure a contact position for each set of coordinates as described above (S700).

The processor 300 may calculate a vertical distance between the reference surface 440 and a contact position using the contact position for each of the coordinates (S800).

The processor 300 may store the vertical distance obtained at each set of coordinates and manage the vertical distances in a profile form (S900).

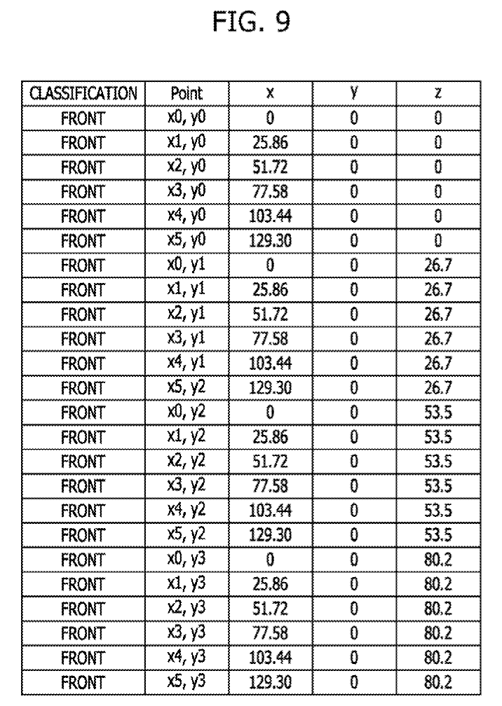

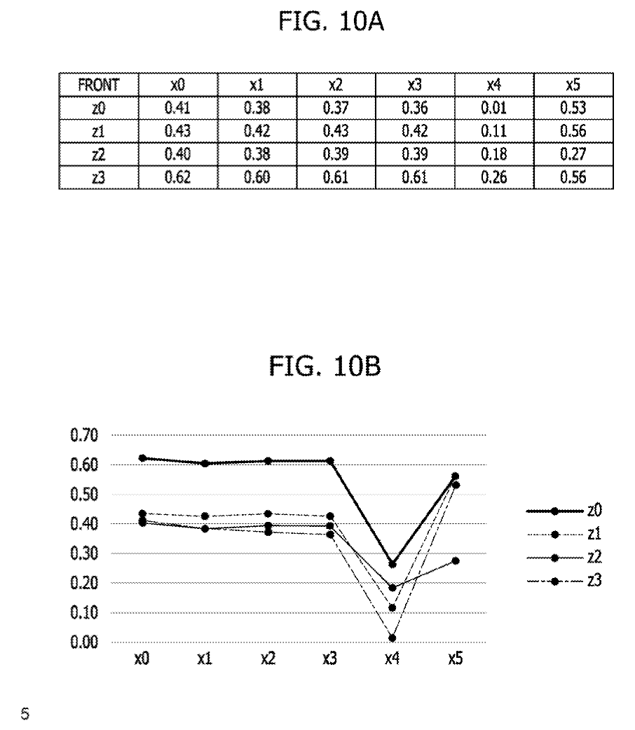

FIG. 9 is a table showing measurement coordinates of the front surface portion according to one or more embodiments of the present disclosure, and FIGS. 10A and 10B are views showing a measurement result of a front surface profile according to one or more embodiments of the present disclosure.

FIG. 9 shows front surface portion measurement coordinates of the battery cell 400, and FIGS. 10A and 10B show profiles at each set of coordinates. Particularly, in FIGS. 10A and 10B, it can be seen that there is a significant change in profile between coordinates (x4,z0), (x4,z1), (x4,z2), and (x4,z3).

According to the present disclosure, a profile of a battery cell can be measured by measuring a distance between a reference surface of the battery cell and a roller while moving the roller to tape the battery cell with insulating tape using the roller.

According to the present disclosure, a profile of a battery cell can be managed within a set error range.

The embodiments described herein may be implemented, for example, as a method or process, a device, a software program, a data stream, or a signal. Although discussed in the context of a single type of implementation (for example, discussed only as a method), features discussed herein may also be implemented in other forms (for example, a device or a program). The device may be implemented by suitable hardware, software, firmware, and the like. The method may be implemented on a device, such as a processor that generally refers to a processing device including a computer, a microprocessor, an integrated circuit, a programmable logic device, etc. The processor includes a communication device such as a computer, a cell phone, a personal digital assistant (PDA), and other devices that facilitate communication of information between the device and end-users.

In hardware implementations, the processing units used to perform the techniques may be implemented within one or more ASICs, DSPs, GPUs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or combinations thereof.

Therefore, the various example logic blocks, modules, and circuits described in conjunction with the present disclosure may be implemented or performed in any combination of general-purpose processors, DSPs, ASICs, FPGAs or other programmable logic devices, discrete gate or transistor logic, discrete hardware components, or those designed to perform the functions described herein. The general-purpose processor may be a microprocessor, but in another example, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any other configurations.

In firmware and/or software implementations, the techniques may be implemented as instructions stored on a computer-readable medium such as random-access memory (RAM), read-only memory (ROM), non-volatile random-access memory (NVRAM), PROM (programmable read-only memory), EPROM (erasable programmable read-only memory), EEPROM (electrically erasable PROM), flash memory, compact discs (CDs), magnetic or optical data storage devices, etc. The instructions may be executable by one or more processors, and may cause the processor(s) to perform certain aspects of the functionality described in the present disclosure.

If implemented in software, the techniques described above may be stored on or transmitted via a computer-readable medium as one or more instructions or code. The computer-readable media include both computer storage media and communication media, including any media that facilitate the transmission of a computer program from one place to another. The storage media may be any available media that can be accessed by a computer. By way of non-limiting example, the computer-readable media may include RAM, ROM, EEPROM, CD-ROM or other optical disc storages, magnetic disk storage or other magnetic storage devices, or any other media that can be used to transport or store the desired program code in the form of instructions or data structures and that can be accessed by a computer. Moreover, any access is appropriately made to a computer-readable medium.

For example, if software is transmitted from websites, servers, or other remote sources using coaxial cables, fiber optic cables, twisted pair cables, digital subscriber lines (DSLs), or wireless technologies such as infrared, radio, and microwave, then the coaxial cables, fiber optic cables, twisted pair cables, digital subscriber lines, or wireless technologies such as infrared, radio, and microwave are included within the definition of media. The disks and discs used herein include CDs, laser discs, optical discs, digital versatile discs (DVDs), floppy disks, and Blu-ray discs, wherein the disks typically reproduce data magnetically, whereas the discs reproduce data optically using lasers. Combinations of the above should also be included within the scope of computer-readable media.

The software modules may reside in RAM memory, flash memory, ROM memory, EPROM memory, EEPROM memory, registers, a hard disk, a removable disk, a CD-ROM, or any other forms of storage media known. An example storage medium may be connected to the processor such that the processor can read information from or write information to the storage medium. In another example, the storage medium may be integrated into the processor. The processor and storage medium may be present within an ASIC. The ASIC may be present within a user terminal. In yet another example, the processor and storage medium may be present as separate components in a user terminal.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for measuring a battery cell profile, the apparatus comprising:
a taping module including a roller and a roller driver;
a processor electrically connected to the taping module; and
a memory which stores a command executed by the processor, the memory being electrically connected to the processor,
wherein the processor is configured to measure a profile of a battery cell using a contact position at which the roller comes into contact with a surface of the battery cell to bring insulating tape into close contact with the battery cell.

2. The apparatus as claimed in claim 1, wherein the processor is configured to measure the profile of the battery cell using a vertical distance between a predetermined reference surface and the contact position.

3. The apparatus as claimed in claim 2, wherein the predetermined reference surface includes at least one of:
a first reference surface defined by a center line in a thickness direction and a center line in a width direction of the battery cell;
a second reference surface defined by the center line in the width direction and a center line in a longitudinal direction of the battery cell; and
a third reference surface defined by the center line in the thickness direction and the center line in the longitudinal direction of the battery cell.

4. The apparatus as claimed in claim 2, wherein the predetermined reference surface is set for each profile measurement section of the battery cell.

5. The apparatus as claimed in claim 4, wherein the profile measurement section of the battery cell includes at least one of both front surface portions, side surface portions, and a bottom portion of the battery cell.

6. The apparatus as claimed in claim 2, wherein the processor is configured to:
set coordinates on the predetermined reference surface, and
measure the vertical distance for each set of coordinates.

7. The apparatus as claimed in claim 2, wherein the processor is configured to calculate:
an initial distance between a position of the predetermined reference surface and an initial position of the roller while moving the roller toward the battery cell;
a movement distance of the roller using the initial position of the roller and the contact position; and
a distance between the predetermined reference surface and the contact position by deducting the movement distance from the initial distance of the roller.

8. The apparatus as claimed in claim 7, wherein the processor is configured to calculate the distance between the predetermined reference surface and the contact position based on an amount of a change in contact position according to close movement of the roller while bringing the roller into close contact with the battery cell and moving the roller.

9. An apparatus for measuring a battery cell profile, the apparatus comprising:
a taping module configured to bring insulating tape into close contact with a battery cell and tape the battery cell using a roller; and
a processor configured to measure a contact position at which the roller comes into contact with a surface of the battery cell while controlling the taping module to tape the battery cell and measure a profile of the battery cell using the contact position.

10. The apparatus as claimed in claim 9, wherein the taping module includes a roller driver configured to move the roller toward the battery cell or configured to bring the roller into close contact with the battery cell and tape the battery cell with the insulating tape.

11. The apparatus as claimed in claim 9, wherein the processor is configured to measure the profile of the battery cell using a vertical distance between a predetermined reference surface and the contact position.

12. The apparatus as claimed in claim 11, wherein the processor is configured to:
set coordinates on the predetermined reference surface, and
measure the vertical distance between the predetermined reference surface and the contact position for each set of coordinates.

13. The apparatus as claimed in claim 12, wherein the processor is configured to calculate:
an initial distance between a position of the predetermined reference surface and an initial position of the roller while moving the roller toward the battery cell;
a movement distance of the roller using the initial position of the roller and the contact position; and
the vertical distance between the predetermined reference surface and the contact position by deducting the movement distance from the initial distance of the roller.

14. The apparatus as claimed in claim 12, wherein the processor is configured to calculate the vertical distance between the predetermined reference surface and the contact position based on an amount of a change in contact position according to close movement of the roller while bringing the roller into close contact with the battery cell and moving the roller.

15. A method of measuring a battery cell profile, the method comprising:
measuring, by a processor, a contact position at which a roller comes into contact with a battery cell while taping the battery cell with insulating tape using the roller; and
measuring, by the processor, a profile of the battery cell using the contact position.

16. The method as claimed in claim 15, wherein measuring the profile of the battery cell includes measuring, by the processor, the profile of the battery cell using a vertical distance between a predetermined reference surface and the contact position.

17. The method as claimed in claim 16, wherein:
measuring the profile of the battery cell includes measuring, by the processor, sets of coordinates on the predetermined reference surface, and
measuring the vertical distance between the predetermined reference surface and the contact position of each of the sets of coordinates.

18. The method as claimed in claim 16, wherein measuring the profile of the battery cell includes calculating, by the processor:
an initial distance between a position of the predetermined reference surface and an initial position of the roller while moving the roller toward the battery cell;
a movement distance of the roller using the initial position of the roller and the contact position; and
the vertical distance between the predetermined reference surface and the contact position by deducting the movement distance from the initial distance of the roller.

19. The method as claimed in claim 16, wherein measuring the profile of the battery cell includes calculating, by the processor, the vertical distance between the predetermined reference surface and the contact position based on an amount of change in contact position according to close movement of the roller while bringing the roller into close contact with the battery cell and moving the roller.
